(19) United States
(12) Patent Application Publication
(10) Pub. No.: US 2018/0056562 A1
(43) Pub. Date: Mar. 1, 2018

(54) RESIN FILLING METHOD

(71) Applicant: AISIN AW CO., LTD., Anjo-shi, Aichi-ken (JP)

(72) Inventor: Motoki KORI, Anjo (JP)

(73) Assignee: AISIN AW CO., LTD., Anjo-shi, Aichi-ken (JP)

(21) Appl. No.: 15/561,797

(22) PCT Filed: May 10, 2016
(86) PCT No.: PCT/JP2016/063900

§ 371 Date: Sep. 26, 2017

(30) Foreign Application Priority Data
May 14, 2015 (JP) 2015-098777

(51) Int. Cl. B29C 45/26; B29C 45/00; B29C 45/04; B29C 45/14; B29C 45/40

(52) U.S. Cl. CPC B29C 45/2669; B29C 45/0046; B29L 2031/7498; B29C 45/14467; B29C 45/40; B29C 45/0441

(57) ABSTRACT

A resin filling method that includes the steps of filling in a filling step the filling clearance with the molten resin pressurized by the pressurizing unit, through the first flow path and the second flow path, with the laminated core being held between the flow path plate in contact with the upper mold and the lower mold; moving the upper mold and the pressurizing unit up with respect to the flow path plate to create a space between the upper mold and the flow path plate; removing residual resin in a resin removing step remaining in the second flow path in the flow path plate, with the flow path plate being located on the laminated core; and moving in a core removing step the flow path plate up from the laminated core and then removing the laminated core from the lower mold.

### BACKGROUND

The present disclosure relates to resin filling methods for filling filling clearances, which are formed by placing magnets in placement holes of a laminated core of a rotating electrical machine rotor, with resin.

A technique of forming placement holes in a laminated core that is a stack of a plurality of electrical steel sheets and filling clearances formed by placing magnets in the placement holes with a thermosetting resin is known as a technique of manufacturing a rotor for use in rotating electrical machines. For example, Japanese Patent Application Publication No. 2011-88329 discloses a resin sealing device using an injection molding method. Japanese Patent Application Publication No. 2011-88329, a core is held between a lower mold unit and an upper mold unit, and clearances each formed between a space accommodating the core and a magnet are filled with molten resin. In the upper mold unit, a third lifting plate having a position restricting tube that restricts the position of the outer peripheral surface of the core is attached at a position below a first lifting plate and a second lifting plate of the upper mold unit having a spool bushing through which molten resin flows, such that the third lifting plate can hang from the first and second lifting plates via support rods. When the upper mold unit is moved downward toward the lower mold unit, the position restricting tube of the third lifting plate restricts the position of the core placed on the lower mold unit, so that the core is held between the lower mold unit and the upper mold unit.

### SUMMARY

In the resin sealing device of Japanese Patent Application Publication No. 2011-88329, when the third lifting plate is moved upward from the core after the clearances in the core are filled with the resin, the resin remaining in a resin flow path in the third lifting plate is separated from the resin filling the clearances in the core. At this time, there is nothing that prevents lifting of the core from the lower mold unit. That is, since the resin remaining in the flow path connects to the resin filling the clearances in the core, the core may be lifted from a lower mold when the third lifting plate is moved upward.

There is a possibility that, with the core being lifted from the lower mold, the resin remaining in the flow path in the third lifting plate may be separated from the resin filling the clearances in the core. In this case, the core may be flawed when the lifted core drops.

An exemplary aspect of the disclosure provides a resin filling method by which residual resin can be removed while preventing lifting of a laminated core and which can thus prevent flaws on the laminated core.

According to an aspect of the present disclosure, a resin filling method for filling a filling clearance formed by an inner wall surface of a placement hole formed in a laminated core of a rotating electrical machine rotor in a direction of a central axis of the laminated core and a magnet placed in the placement hole, wherein the resin filling method utilizes an upper mold that has a first flow path, a pressurizing unit that is coupled to the upper mold and that introduces pressurized molten resin into the first flow path; a flow path plate that has a second flow path for guiding the molten resin from the first flow path into the filling clearance, that is located below the upper mold, and that can be moved up and down relative to the upper mold; and a lower mold on which the laminated core is placed. The method includes the steps of filling in a filling step the filling clearance with the molten resin pressurized by the pressurizing unit, through the first flow path and the second flow path, with the laminated core being held between the flow path plate in contact with the upper mold and the lower mold; moving the upper mold and the pressurizing unit up with respect to the flow path plate to create a space between the upper mold and the flow path plate; removing residual resin in a resin removing step remaining in the second flow path in the flow path plate, with the flow path plate being located on the laminated core; and moving in a core removing step the flow path plate up from the laminated core and then removing the laminated core from the lower mold.

In the above resin filling method, the residual resin remaining in the second flow path in the flow path plate is separated from the resin filling the filling clearance of the laminated core, while preventing lifting of the laminated core by the flow path plate.

According to the resin filling method, the residual resin can thus be removed while preventing lifting of the laminated core, and flaws on the laminated core can be prevented.

### BRIEF DESCRIPTION OF THE DRAWINGS

FIG. 1 is an illustration of a resin filling device of a first embodiment which is filling filling clearances of a laminated core with resin.

FIG. 2 is an illustration of the resin filling device of the first embodiment which is removing residual resin from a flow path plate placed on the laminated core.

FIG. 3 is an illustration of the resin filling device of the first embodiment which is removing the laminated core filled with the resin.

FIG. 4 is an illustration of the laminated core of the first embodiment having magnets placed therein as viewed in the direction of the central axis of the laminated core.

FIG. 5 is an illustration of a resin filling device of a second embodiment which is filling filling clearances of a laminated core with resin.

FIG. 6 is an illustration of the resin filling device of the second embodiment which is removing residual resin from a flow path plate placed on the laminated core.

### DETAILED DESCRIPTION OF EMBODIMENTS

Preferred embodiments of the above resin filling method will be described below.

First, specific functions and effects of the above resin filling method will be described.

In the resin filling method, in the filling step, the laminated core is held between the flow path plate having the upper mold located thereon and the lower mold, and the filling clearance is filled with the molten resin pressurized by the pressurizing unit through the first flow path and the second flow path. At this time, the filling clearance is filled with the resin and the residual resin, which is an unwanted part of the resin, remains in the first flow path and the second flow path.

Thereafter, in the resin removing step, the upper mold and the pressurizing unit are moved upward, and with the flow path plate being located on the laminated core, the residual resin remaining in the second flow path in the flow path plate is removed. Specifically, when the upper mold and the pressurizing unit are moved upward, the flow path plate is moved downward relative to the upper mold and the pressurizing unit, creating a space between the upper mold and the flow path plate. The residual resin remaining in the second flow path is removed to the outside by using the space between the upper mold and the flow path plate.

At this time, since the flow path plate is located on the laminated core, the residual resin remaining in the second flow path can be separated from the resin filling the clearance in the laminated core while preventing lifting of the laminated core by the flow path plate. The laminated core placed on the lower mold can thus be prevented from being lifted in the direction of the central axis of the laminated core, and the residual resin remaining in the second flow path can be separated from the resin filling the filling clearance in the laminated core. Since the laminate core is not lifted and therefore does not drop, flaws on the laminated core can be prevented.

Subsequently, in the core removing step, the upper mold and the pressurizing unit are further moved upward to lift the flow path plate from the laminated core, and the laminated core is then removed from the lower mold.

In the resin filling method, the first flow path may be formed so that its flow-path sectional area increases toward a lower end of the first flow path.

In this case, the residual resin remaining in the first flow path whose flow-path sectional area increases toward the lower end of the first flow path connects to the residual resin remaining in a horizontal flow path portion of the second flow path. The residual resin remaining in the first flow path can be easily removed in this connected state from the first flow path when the upper mold and the pressurizing unit are moved upward.

The second flow path may have the horizontal flow path portion that is formed in an upper surface of the flow path plate so as to connect to the first flow path, and a gate flow path portion that is formed so as to connect to the horizontal flow path portion and so that its flow-path sectional area decreases toward a lower end of the gate flow path portion, and that faces the filling clearance at its lower opening end.

In this case, since the flow-path sectional area of the gate flow path portion of the second flow path decreases toward the lower end of the gate flow path portion, the residual resin remaining in the second flow path can be easily removed with the upper mold and the pressurizing unit in the lifted state. The residual resin remaining in the gate flow path portion can be easily separated at the lower opening end of the gate flow path portion from the surface of the resin filling the filling clearance of the laminated core.

A plurality of the placement holes may be formed in a radial pattern about the central axis of the laminated core. The second flow path in the flow path plate may guide the molten resin into the filling clearance formed in one or more of the plurality of placement holes. The resin filling method may use a relative rotation mechanism that rotates at least the flow path plate and the lower mold relative to each other about the central axis of the laminated core placed on the lower mold, and that selects the one or more of the plurality of placement holes as selected placement holes and sequentially causes the selected placement holes to face the second flow path in the flow path plate. In the filling step, the filling clearance in any of the selected placement holes may be filled with the molten resin through the second flow path in the flow path plate. In the resin removing step, the residual resin remaining in the second flow path may be removed. An indexing step of changing the selected placement holes to the placement holes that have not been filled with the molten resin by the relative rotation mechanism may be performed after the resin removing step and before the core removing step. The filling step and the resin removing step may then be performed again.

In this case, at least the flow path plate and the lower mold are rotated relative to each other by a predetermined angle by the relative rotation mechanism, whereby filling with the molten resin and removal of the residual resin can be performed for a predetermined number of selected placement holes of the laminated core at a time. With this configuration, a pressure that is applied to the molten resin when the filling clearance in each selected placement hole is filled with the molten resin can be easily increased as compared to the case where the filling clearances in all the placement holes are simultaneously filled with the molten resin. This configuration can thus enhance efficiency in filling the filling clearance with the molten resin and can reduce the size of the pressurizing unit and can thus reduce the size of a device that is used in the resin filling method.

### Embodiments

Embodiments of a resin filling method will be described with reference to the accompanying drawings.

### First Embodiment

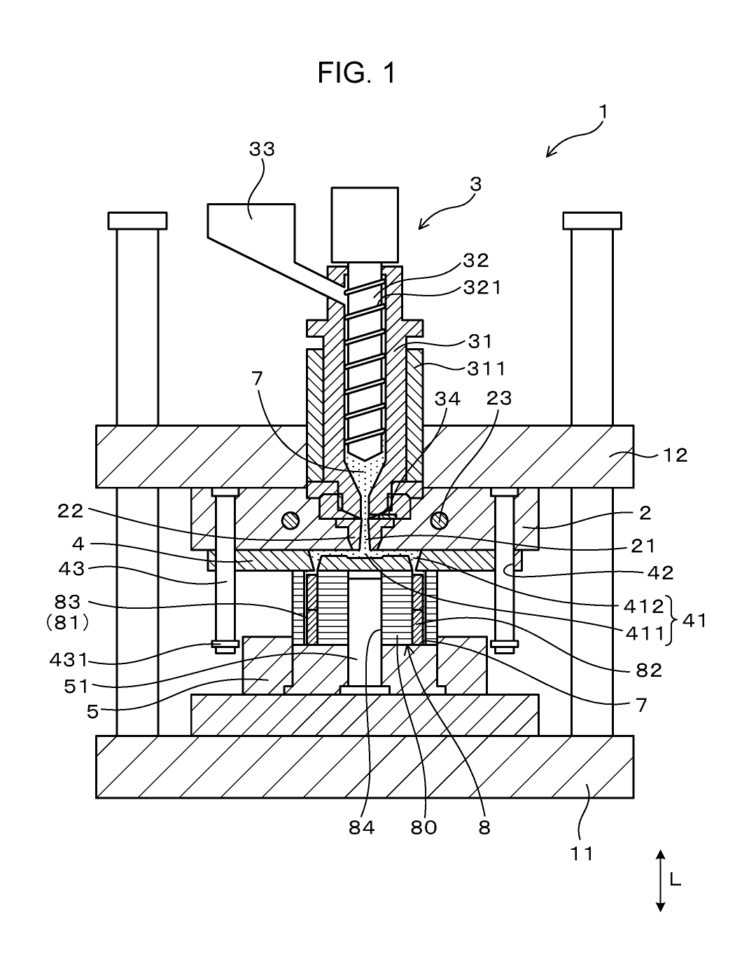

In the resin filling method of the present embodiment, as shown in FIG. 1, magnets 82 are placed in placement holes 81 extending in the direction L of the central axis of a laminated core 8 of a rotating electrical machine rotor, and filling clearances 83 each created between the inner wall surface of the placement hole 81 and the magnet 82 are filled with resin 7. A resin filling device 1 including an upper mold 2, a pressurizing unit 3, a flow path plate 4, and a lower mold 5 is used in the resin filling method. The upper mold 2 has a first flow path 21 into which molten resin 7 is introduced from the pressurizing unit 3. The pressurizing unit 3 is coupled to the upper part of the upper mold 2 and introduces the pressurized molten resin 7 into the first flow path 21. The flow path plate 4 is located below the upper mold 2 and can be moved up and down relative to the upper mold 2. The flow path plate 4 of the present embodiment is attached such that it can hang down from the upper mold 2. The flow path plate 4 has a second flow path 41 through which the molten resin 7 is introduced from the first flow path 21 into the filling clearances 83. The laminated core 8 is placed on the lower mold 5, and the lower mold 5 holds the laminated core 8 between the lower mold 5 itself and the upper mold 2 and the flow path plate 4.

In the resin filling method, a filling step, a resin removing step, and a core removing step are performed to fill the filling clearances 83 in the placement holes 81 of the laminated core 8 with the molten resin 7.

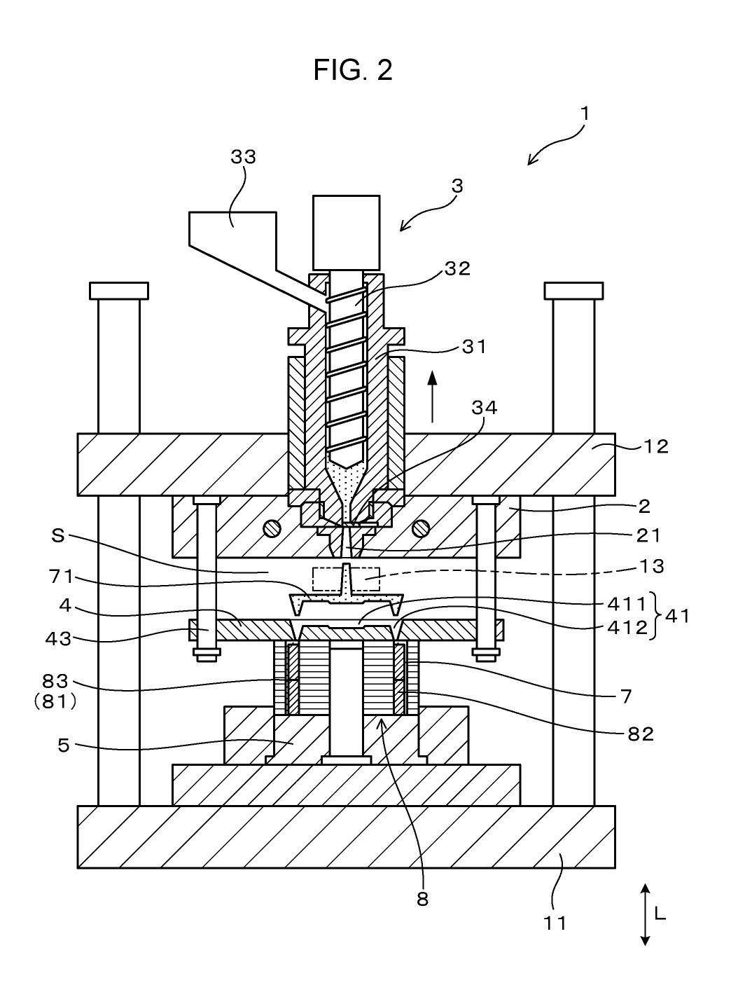

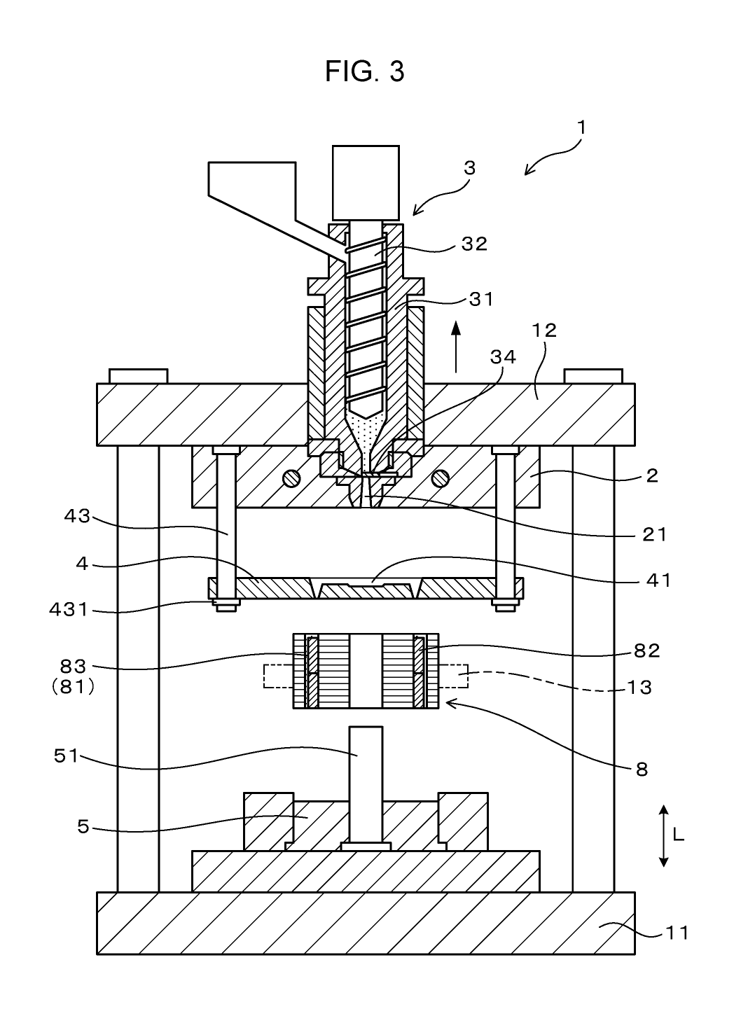

In the filling step, as shown in FIG. 1, the laminated core 8 is sandwiched between the flow path plate 4 in contact with the upper mold 2 and the lower mold 5, and the filling clearances 83 are filled with the molten resin 7 pressurized by the pressurizing unit 3 through the first flow path 21 and the second flow path 41. In the resin removing step, as shown in FIG. 2, the upper mold 2 and the pressurizing unit 3 are lifted from the flow path plate 4 to create a space S between the upper mold 2 and the flow path plate 4. Thereafter, with the flow path plate 4, which hangs down from the upper mold 2, being located on the laminated core 8, residual resin 71 remaining in the second flow path 41 of the flow path plate 4 is removed. In the core removing step, as shown in FIG. 3, after the upper mold 2 and the pressurizing unit 3 are further lifted and the flow path plate 4 is lifted from the laminated core 8, the laminated core 8 is removed from the lower mold 5.

The resin filling device 1 etc. used in the resin filling method of the present embodiment will be described first.

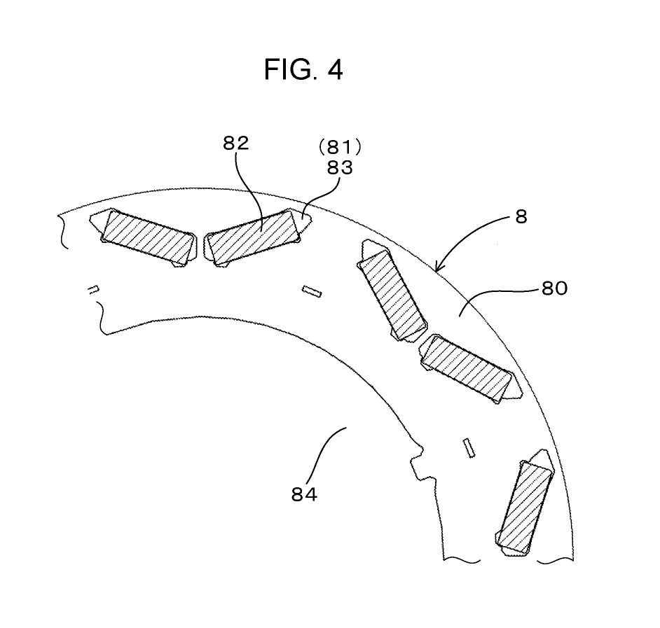

The rotating electrical machine rotor of the present embodiment is an inner rotor that is placed near the inner periphery of a stator and rotates relative to the stator. The laminated core 8 is formed by a plurality of electrical steel sheets 80 stacked in the direction L of the central axis of the laminated core 8. As shown in FIG. 4, the laminated core 8 has the plurality of placement holes 81 formed in a radial pattern about the central axis of the laminated core 8. Each placement hole 81 is formed so as to extend through the plurality of electrical steel sheets 80. The laminated core 8 further has a central hole 84 in the center which extends in the direction L of the central axis of the laminated core 8. The magnets (permanent magnets) 82 placed in the placement holes 81 are fixed to the laminated core 8 with the resin 7 filling the filling clearances 83.

The resin is 7 is a thermoplastic resin that becomes soft and pliable when heated and hardens when cooled. Resin filling methods for conventional rotating electrical machine rotors use a thermosetting resin to fix the magnets 82 in the placement holes 81 as heat resistance is prioritized. However, the resin filling method of the present embodiment uses a thermoplastic resin that can ensure heat resistance. Preferably, the thermoplastic resin is liquid crystal polyester (LCP) that is a highly heat-resistant liquid crystal polymer.

As shown in FIG. 1, the lower mold 5 is attached to the upper surface of a bed 11, and the upper mold 2 is attached to the lower surface of a lifting base 12 that is moved up and down relative to the bed 11. The pressurizing unit 3 is attached to the lifting base 12 such that the axis of a screw 32 extends in the up-down direction (vertical direction). The lifting base 12 is moved up and down by a lifting mechanism, not shown. A positioning collet 51, which is inserted in the central hole 84 of the laminated core 8 to position the laminated core 8 with respect to the lower mold 5, is disposed in the lower mold 5 so as to project upward beyond the lower mold 5.

The pressurizing unit 3 has a cylinder 31 that stores and heats the resin 7, the screw 32 placed in the cylinder 31 such that the screw 32 can rotate and slide therein, and a hopper 33 that supplies solid resin 7 into the cylinder 31. The cylinder 31 is provided with a heater 311, and the screw 32 has a helical projection 321 on its outer peripheral surface. The solid resin 7 supplied from the hopper 33 into the cylinder 31 is melted by heating with the heater 311 of the cylinder 31, and the molten resin 7 is pressurized by the helical projection 321 of the screw 32 and ejected into the first flow path 21 of the upper mold 2.

As shown in FIG. 1, the upper mold 2 has embedded therein a spool bushing 22 that has the first flow path 21 formed therein, and a cooler 23 that cools the molten resin 7 ejected from the pressurizing unit 3 into the first flow path 21. The first flow path 21 is formed so that its flow-path sectional area increases toward the lower end of the first flow path 21. The cooler 23 may be embedded in the flow path plate 4 or the lower mold 5 depending on fluidity of the resin 7.

Hanging rods 43 that allow the flow path plate 4 to hang down from the upper mold 2 are disposed in the upper mold 2 so as to extend downward. The flow path plate 4 has insertion holes 42 through which the hanging rods 43 are inserted, and each hanging rod 43 has a catch-and-hold portion 431 near its lower end which catches and holds the flow path plate 4.

A blocking plate 34 that can block the first flow path 21 in the spool bushing 22 is placed between the lower end of the cylinder 31 and the spool bushing 22. The blocking plate 34 is withdrawn from the first flow path 21 when the molten resin 7 is to be introduced into the first flow path 21, and blocks the first flow path 21 when introduction of the molten resin 7 into the first flow path 21 is to be stopped. When the filling clearances 83 are filled with the resin 7, the first flow path 21 is blocked with the blocking plate 34 to separate the residual resin 71 remaining in the first flow path 21 from the resin 7 in the cylinder 31.

The second flow path 41 in the flow path plate 4 is formed by a horizontal flow path portion 411 and a plurality of gate flow path portions 412. The horizontal flow path portion 411 is formed in the shape of a groove in the upper surface of the flow path plate 4 so as to connect to the first flow path 21. When the upper surface of the flow path plate 4 is mated with the lower surface of the upper mold 2, the horizontal flow path portion 411 forms a flow path through which the molten resin 7 flows. The horizontal flow path portion 411 is shaped such that the first flow path 21 communicates with the plurality of gate flow path portions 412 through the horizontal flow path portion 411.

As shown in FIG. 1, the gate flow path portions 412 extend from the upper surface of the flow path plate 4 to the lower surface thereof so as to connect to the horizontal flow path portion 411. Each gate flow path portion 412 is formed so that its flow-path sectional area decreases toward the lower end of the gate flow path portion 412. Each gate flow path portion 412 has the smallest flow-path sectional area at its lower opening end, and the lower opening end of each gate flow path portion 412 faces the filling clearance 83. The number of gate flow path portions 412 is the same as that of filling clearances 83.

The second flow path 41 in the flow path plate 4 of the present embodiment is formed so that the first flow path 21 communicates with the plurality of filling clearances 83 in the laminated core 8 through the second flow path 41. The molten resin 7 is simultaneously supplied from the first flow path 21 into the plurality of filling clearances 83.

As shown in FIG. 3, when the upper mold 2 and the pressurizing unit 3 are withdrawn to an upper position, the flow path plate 4 hangs, by its own weight, from the upper mold 2 via the hanging rods 43. When the upper mold 2 and the pressurizing unit 3 are moved downward toward the laminated core 8, the flow path plate 4 is placed on the laminated core 8, and the upper mold 2 and the pressurizing unit 3 are moved downward until the upper mold 2 is located on the flow path plate 4. Thrust of the lifting base 12 is applied via the upper mold 2 and the flow path plate 4 to the laminated core 8 placed on the lower mold 5, and the laminated core 8 is thus held between the flow path plate 4 and the lower mold 5.

As shown in FIG. 2, when the upper mold 2 and the pressurizing unit 3 are moved upward away from the laminated core 8, the flow path plate 4 remains on the laminated core 8 until the flow path plate 4 is caught and held by the catch-and-hold portions 431 of the hanging rods 43. As shown in FIG. 3, when the upper mold 2 and the pressurizing unit 3 are further moved upward and the flow path plate 4 is caught and held by the catch-and-hold portions 431 of the hanging rods 43, the flow path plate 4 is separated from the laminated core 8 and is moved upward with the upper mold 2 and the pressurizing unit 3.

Next, the resin filling method of the present embodiment will be described in detail.

In the resin filling method, with the flow path plate 4 being placed on the laminated core 8 to prevent lifting of the laminated core 8, the residual resin 71 remaining in the second flow path 41 in the flow path plate 4 is separated from the resin 7 filling the filling clearances 83 in the laminated core 8.

Specifically, in a preparation step, the laminated core 8 is first placed on the lower mold 5 so that the positioning collet 51 in the lower mold 5 is inserted into the central hole 84 of the laminated core 8. The magnets 82 are placed in the plurality of placement holes 81 in the laminated core 8. At this time, the magnet 82 are positioned in each placement core 81 as appropriate to form the filling clearance 83 between the inner wall surface of each placement hole 81 and the outer wall surface of each magnet 82.

In the pressurizing unit 3, solid resin 7 is introduced from the hopper 33 into the cylinder 31, and the resin 7 is heated and melted with the heater 311 of the cylinder 31. At this time, the lifting base 12 provided with the upper mold 2, the pressurizing unit 3, and the flow path plate 4 is located at a lifted position. Subsequently, in the filling step, the lifting base 12 is moved downward by the lifting mechanism so that the upper mold 2, the pressurizing unit 3, and the flow path plate 4 become closer to the laminated core 8. The flow path plate 4 is thus placed on the laminated core 8, the upper mold 2 contacts the flow path plate 4, and the laminated core 8 is held between the flow path plate 4 having the upper mold 2 located thereon and the lower mold 5 due to thrust of the lifting mechanism.

Thereafter, as shown in FIG. 1, the screw 32 of the pressurizing unit 3 is rotated to supply the molten resin 7 in the cylinder 31 into the first flow path 21 in the upper mold 2. The blocking plate 34 is withdrawn in advance from the first flow path 21. The molten resin 7 thus supplied into the first flow path 21 flows from the first horizontal flow path portion 411 to the gate flow path portions 412 of the second flow path 41 and fills the filling clearances 83 in the placement holes 81 through the gate flow path portions 412. When flowing through the first flow path 21, the molten resin 7 is cooled by the cooler 23 embedded in the upper mold 2. The filling clearances 83 are thus filled with the resin 7 and the residual resin 71, which is an unwanted part of the resin 7, remains in the first flow path 21 and the second flow path 41. After the filling clearances 83 are filled with the resin 7, the first flow path 21 is blocked by the blocking plate 34.

Subsequently, after the resin 7 in the filling clearances 83 and the flow paths 21, 41 hardens, the resin removing step is performed as shown in FIG. 2. Namely, the lifting base 12 is moved upward by the lifting mechanism to such a predetermined position that the flow path plate 4 is not separated from the laminated core 8. At this time, with the flow path plate 4 remaining on the laminated core 8, the upper mold 2 and the pressurizing unit 3 are moved upward to create the space S between the upper mold 2 and the flow path plate 4. The residual resin 71 remaining in the first flow path 21 whose flow-path sectional area increases toward the lower end of the first flow path 21 connects to the residual resin 71 remaining in the horizontal flow path portion 411 of the second flow path 41, and is removed in this connected state from the first flow path 21 when the upper mold 2 is lifted from the flow path plate 4.

At this time, more specifically, the residual resin 71 remaining in the first flow path 21 has been separated from the resin 7 in the cylinder 31 by the blocking plate 34. When the residual resin 71 remaining in the first flow path 21 hardens, the residual resin 71 contracts in such a direction that the residual resin 71 separates from the tapered inner wall surface of the first flow path 41. The residual resin 71 remaining in the first flow path 21 is thus easily removed from the first flow path 21. The residual resin 71 remaining in the first flow path 21 is exposed such that the residual resin 71 projects upward with respect to the upper surface of the flow path plate 4.

Subsequently, as shown in FIG. 2, the residual resin 71 that had remained in the first flow path 21 is held by an unloading device 13 by using the space S between the upper mold 2 and the flow path plate 4, and the residual resin 71 remaining in the second flow path 41 is removed from the second flow path 41. When the resin 7 hardens, the residual resin 71 remaining in each gate flow path portion 412 of the second flow path 41 whose flow-path sectional area decreases toward the lower end of the gate flow path portion 412 contracts in such a direction that the residual resin 71 separates from a part of the tapered inner wall surface of the gate flow path portion 412 which is located on the radially outer side of the laminated core 8. The residual resin 71 thus adheres to a part of the tapered inner wall surface of each gate flow path portion 412 which is located on the radially inner side of the laminated core 8. Accordingly, at the lower opening ends of the gate flow path portions 412, the residual resin 71 can be easily separated from the surface of the resin 7 filling the filling clearances 83 in the laminated core 8.

As described above, the residual resin 71 remaining in the first flow path 21 is held by the unloading device 13 and the entire residual resin 71 remaining in the first flow path 21 and the second flow path 41 is lifted by the unloading device 13, whereby the entire residual resin 71 remaining in the first flow path 21 and the second flow path 41 is separated from the surface of the resin 7 filling the filling clearances 83 in the laminated core 8. The entire residual resin 71 can thus be easily removed.

When the residual resin 71 remaining in the gate flow path portions 412 of the second flow path 41 is separated from the resin 7 filling the filling clearances 83, the flow path plate 4 is located on the laminated core 8, which prevents lifting of the laminated core 8. Since the laminated core 8 is not lifted and therefore does not drop, flaws on the laminated core 8 can be prevented. Moreover, when the residual resin 71 is separated from the resin 7, the laminated core 8 placed on the lower mold 5 is less likely to be displaced in the direction L of the central axis of the laminated core 8.

Furthermore, when the residual resin 71 is separated from the resin 7 filling the filling clearances 83, the surface of the resin 7 filling the filling clearances 83 can be pressed by the flow path plate 4. The resin 7 filling the filling clearances 83 is thus less likely to have a rough surface (separation surface).

Subsequently, as shown in FIG. 3, in the core removing step, the lifting base 12 is further moved upward by the lifting mechanism. The upper mold 2 and the pressurizing unit 3 are thus further moved upward, and the flow path plate 4 is caught and held by the catch-and-hold portions 431 of the hanging rods 43, so that the flow path plate 4 is lifted by the hanging rods 43 and hangs, by its own weight, from the upper mold 2. After the flow path plate 4 is separated upward from the laminated core 8, the laminated core 8 is removed from the lower mold 5 by removing the positioning collet 51 from the central hole 84 of the laminated core 8.

As described above, according to the resin filling method of the present embodiment, the residual resin 71 can be removed while preventing lifting of the laminated core 8, and flaws on the laminated core 8 can be prevented.

### Second Embodiment

In a resin filling method of the present embodiment, the filling clearances 83 in the plurality of placement holes 81 are sequentially filled with the resin 7 by filling a predetermined number of filling clearances 83 with the resin 7 at a time, instead of simultaneously filling all of the filling clearances 83 in the plurality of placement holes 81 of the laminated core 8 with the resin 7.

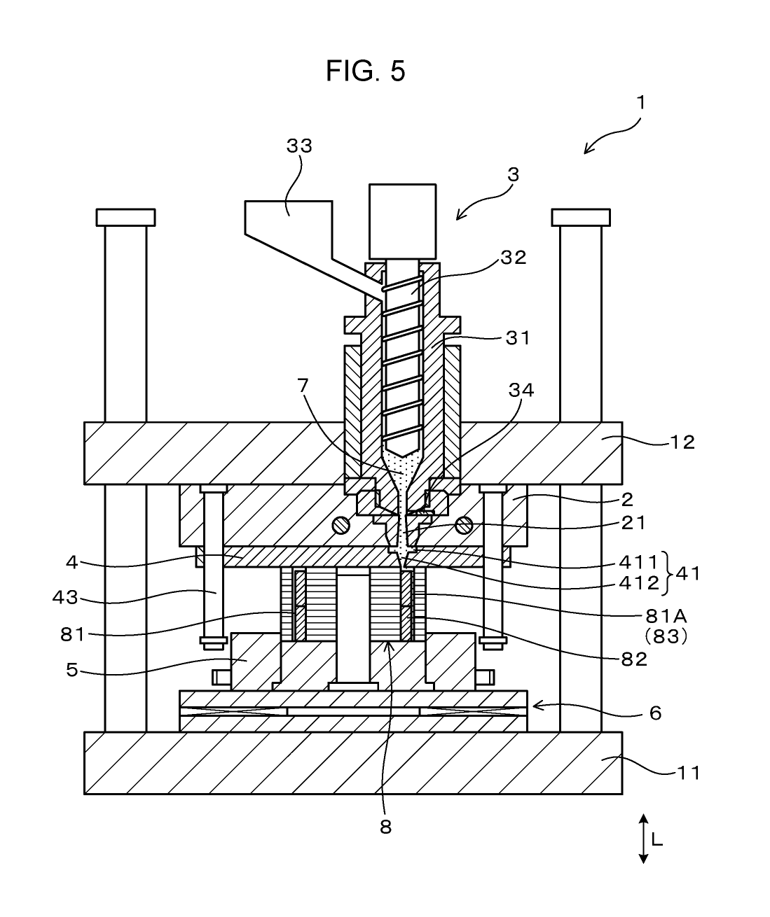

As shown in FIG. 5, the second flow path 41 in the flow path plate 4 of the present embodiment guides the molten resin 7 into the filling clearances 83 in a predetermined number of placement holes 81 out of the plurality of placement holes 81 in the laminated core 8. The resin filling device 1 that is used in the resin filling method of the present embodiment has a relative rotation mechanism 6 that rotates the lower mold 5 by predetermined angles according to predetermined intervals in the circumferential direction about the central axis of the laminated core 8 at which the plurality of placement holes 81 are formed.

The relative rotation mechanism 6 rotates the lower mold 5 relative to the upper mold 2, the pressurizing unit 3, and the flow path plate 4 about the central axis of the laminated core 8 placed on the lower mold 5 such that each of a predetermined number of placement holes 81, namely selected placement holes 81A, sequentially faces the gate flow path portion 412 of the second flow path 41 in the flow path plate 4.

The selected placement holes 81A of the present embodiment are two placement holes 81 that are located adjacent to each other. In order to reduce the flow path length of the horizontal flow path portion 411 of the second flow path 41, the pressurizing unit 3 is located at a position offset in the radial direction of the laminated core 8 from the position facing the central part of the laminated core 8. The pressurizing unit 3 may be positioned so as to face the central part of the laminated core 8.

The selected placement holes 81A may be determined in various patterns as long as the selected placement holes 81A are a predetermined number of placement holes 81 out of the plurality of placement holes 81. For example, the selected placement holes 81A may not be a predetermined number of placement holes 81 that are located adjacent to each other, but may be a predetermined number of placement holes 81 located on both sides in the radial direction of the central axis of the laminated core 8. For example, the plurality of placement holes 81 may be divided into two to four groups, and the placement holes 81, one from each group, may be determined as the selected placement holes 81A.

The relative rotation mechanism 6 may not rotate the lower mold 5, but may rotate the flow path plate 4, or the upper mold 2, the pressurizing unit 3, and the flow path plate 4, relative to the lower mold 5 by predetermined angles.

In the resin filling method of the present embodiment, the filling step and the resin removing step are repeatedly performed for each group of a predetermined number of placement holes 81, thereby filling all of the filling clearances 83 with the molten resin 7. After the resin removing step and before the core removing step, an indexing step is performed to change the selected placement holes 81A to those placement holes 81 which have not been filled with the molten resin 7 by the relative rotation mechanism 6.

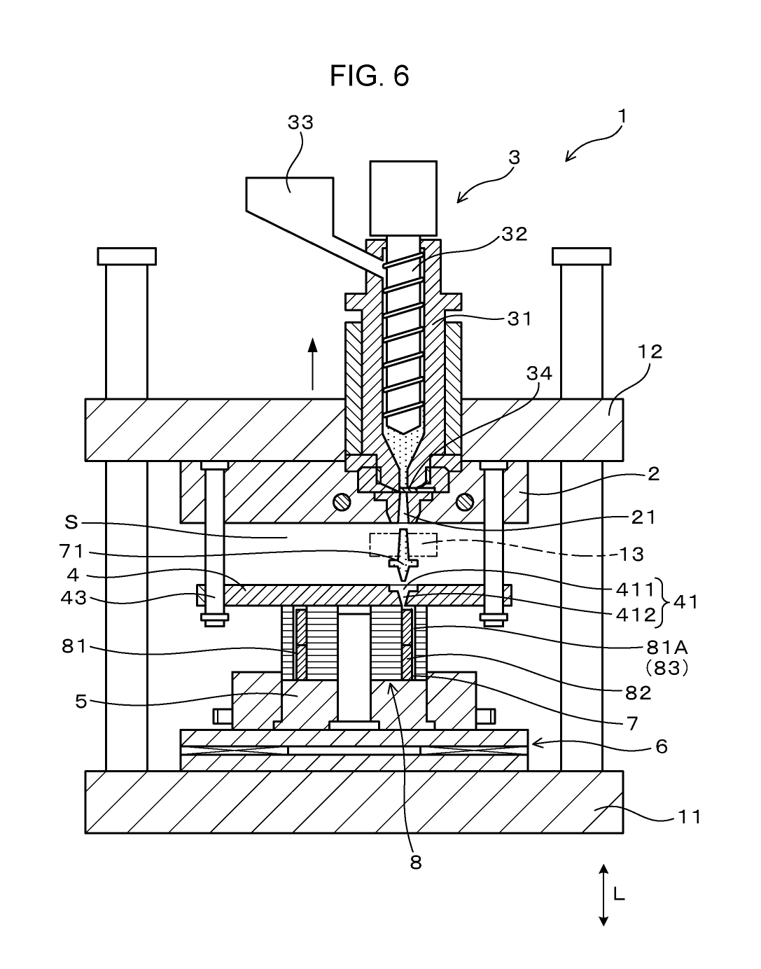

First, as shown in FIG. 5, in the filling step, the filling clearances 83 in a predetermined number of first selected placement holes 81A are filled with the molten resin 7 through the second flow path 41 in the flow path plate 4. Next, as shown in FIG. 6, in the resin removing step, with the flow path plate 4 remaining on the laminated core 8, the upper mold 2 and the pressurizing unit 3 are moved upward to a predetermined position. The residual resin 71 remaining in the first flow path 21 and the entire second flow path 41 is removed by using the space S created between the upper mold 2 and the flow path plate 4.

Thereafter, in the indexing step, the lower mold 5 is rotated by the predetermined angle by the relative rotation mechanism 6 to change the selected placement holes 81A from the first selected placement holes 81A to second selected placement holes 81A that have not been filled with the molten resin 7. Subsequently, the filling step is performed again to fill the filling clearances 83 of the predetermined number of second selected placement holes 81A with the molten resin 7 through the second flow path 41 in the flow path plate 4. The resin removing step is then performed again. Namely, with the flow path plate 4 remaining on the laminated core 8, the upper mold 2 and the pressurizing unit 3 are moved upward to the predetermined position. The residual resin 71 remaining in the first flow path 21 and the entire second flow path 41 is removed by using the space S created between the upper mold 2 and the flow path plate 4.

The filling step, the resin removing step, and the indexing step can be performed the number of times corresponding to the number of groups of the placement holes 81. After the filling clearances 83 in all the placement holes 81 are filled with the resin 7 and the residual resin 71 remaining in the first flow path 21 and the entire second flow path 41 is removed, the core removing step is performed in which the laminated core 8 is removed from the lower mold 5.

In the present embodiment, relative rotation between the lower mold 5 and the upper mold 2, the pressurizing unit 3, and the flow path plate 4 by the predetermined angle is made by the relative rotation mechanism 6, whereby a predetermined number of selected placement holes 81A of the laminated core 8 can be filled with the molten resin 7 at a time and the residual resin 71 can be removed. With this configuration, the pressure that is applied to the molten resin 7 when the filling clearance 83 in each selected placement hole 81A is filled with the molten resin 7 can be easily increased as compared to the case where the filling clearances 83 in all the placement holes 81 are simultaneously filled with the molten resin 7. This configuration can thus enhance efficiency in filling the filling clearances 83 with the molten resin 7 and can reduce the size of the pressurizing unit 3 and can thus reduce the size of the resin filling device 1.

In the present embodiment, other configurations and the components denoted by the same reference characters in the figures as the first embodiment are similar to those of the first embodiment, and functions and effects of the present embodiment are similar to those of the first embodiment.

(Other Modifications)

In the first and second embodiments, the magnets 82 are placed in the placement holes 81 after the laminated core 8 is placed on the lower mold 5. However, after the laminated core 8 are placed on a loading plate-like pallet and the magnets 82 are placed in the placement holes 81 in the laminated core 8, the plate-like pallet may be carried so as to be placed on the lower mold 5.

In the first and second embodiments, the flow path plate 4 can hang, by its own weight, from the upper mold 2 and is placed on the surface of the laminated core 8. However, the flow path plate 4 may be attached so that it can be moved up and down with respect to the lower mold 5 by a lifting mechanism mounted on the lower mold 5. Alternatively, the flow path plate 4 may be attached so that it can be moved up and down with respect to the upper mold 2 by a lifting mechanism mounted on the upper mold 2. In these cases, when the residual resin 71 remaining in the second flow path 41 in the flow path plate 4 is removed from the second flow path 41, the laminated core 8 may be pressed downward by the lifting mechanism mounted on the lower mold 5 or the upper mold 2.

The first and second embodiments are described with respect to the case where the pressurizing unit 3 serving as a single screw cylinder is used. However, a plurality of pressurizing units 3 may be mounted on the upper mold 2.

The resin filling methods described in the first and second embodiments are injection molding methods using the resin 7 that is a thermoplastic resin. Accordingly, the molten resin 7 can be stored in the pressurizing unit 3. According to the resin filling methods described in the first and second embodiments, loss of the resin material can therefore be reduced as compared to conventional common resin filling methods using a thermosetting resin, and running cost of the resin filling device 1 can be reduced.

In the case of using a thermosetting resin to fill the laminated core 8, a tablet material is commonly used which has a size corresponding to the amount of thermosetting resin that is used to fill the laminated core 8. Accordingly, a plurality of types of thermosetting resin tablet materials need to be prepared in order to fill laminated cores 8 of a plurality of sizes with a thermosetting resin. However, in the case of using a thermoplastic resin to fill the laminated core 8, a granular material can be commonly used. The thermoplastic resin can therefore be flexibly used for laminated cores 8 of a plurality of sizes.

1. A resin filling method for filling a filling clearance formed by an inner wall surface of a placement hole formed in a laminated core of a rotating electrical machine rotor in a direction of a central axis of the laminated core and a magnet placed in the placement hole, wherein
the resin filling method utilizes an upper mold that has a first flow path, a pressurizing unit that is coupled to the upper mold and that introduces pressurized molten resin into the first flow path, a flow path plate that has a second flow path for guiding the molten resin from the first flow path into the filling clearance, that is located below the upper mold, and that can be moved up and down relative to the upper mold, and a lower mold on which the laminated core is placed, the method comprising:
filling in a filling step the filling clearance with the molten resin pressurized by the pressurizing unit, through the first flow path and the second flow path, with the laminated core being held between the flow path plate in contact with the upper mold and the lower mold;
moving the upper mold and the pressurizing unit up with respect to the flow path plate to create a space between the upper mold and the flow path plate;
removing residual resin in a resin removing step remaining in the second flow path in the flow path plate, with the flow path plate being located on the laminated core; and
moving in a core removing step the flow path plate up from the laminated core and then removing the laminated core from the lower mold.

2. The resin filling method according to claim 1, wherein
the first flow path is formed so that its a flow-path sectional area of the first flow path increases toward a lower end of the first flow path.

3. The resin filling method according to claim 1, wherein
the second flow path has a horizontal flow path portion that is formed in an upper surface of the flow path plate so as to connect to the first flow path, and a gate flow path portion that is formed so as to connect to the horizontal flow path portion and so that a flow-path sectional area of the gate flow path portion decreases toward a lower end of the gate flow path portion, and that faces the filling clearance at is lower opening end of the gate flow path portion

4. The resin filling method according to claim 1, wherein
the resin is a thermoplastic resin.

5. The resin filling method according to claim 1, wherein
a plurality of the placement holes are formed in a radial pattern about the central axis of the laminated core,
the second flow path in the flow path plate guides the molten resin into the filling clearance formed in one or more of the plurality of placement holes,
the resin filling method uses a relative rotation mechanism that rotates at least the flow path plate and the lower mold relative to each other about the central axis of the laminated core placed on the lower mold, and that selects the one or more of the plurality of placement holes as selected placement holes and sequentially causes the selected placement holes to face the second flow path in the flow path plate,
in the filling step, the filling clearance in any of the selected placement holes is filled with the molten resin through the second flow path in the flow path plate,
in the resin removing step, the residual resin remaining in the second flow path is removed,
changing the selected placement holes to the placement holes that have not been filled with the molten resin by the relative rotation mechanism is performed after the resin removing step and before the core removing step, and
the filling step and the resin removing step are then performed again.
